(19) United States
(12) Patent Application Publication
(10) Pub. No.: US 2011/0313890 A1
(43) Pub. Date: Dec. 22, 2011

(54) METHOD AND SYSTEM FOR DISTRIBUTING DIGITAL BOOKS

(76) Inventors: Ronald DICKE, Ottawa (CA); Gordon FREEDMAN, Ottawa (CA)

(21) Appl. No.: 13/160,974

(22) Filed: Jun. 15, 2011

Related U.S. Application Data
(60) Provisional application No. 61/355,301, filed on Jun. 16, 2010.

(51) Int. Cl. G06F 15/16; G06Q 30/00

(52) U.S. Cl. 705/27.1; 709/217; 709/206

(57) ABSTRACT

A method is provided in which a user, in dependence upon purchasing a physical copy of a first book, receives a code comprising an identifier of the first book. The code is provided to an electronic device associated with the user, via an input portion thereof A communication session is established between the electronic device and a digital bookstore via a communication network. The user transmits the code from the electronic device to the digital bookstore via the communication network during the communication session, and in response to providing the code, the user receives from the digital bookstore via the communication network a digital book copy of the first book. The digital book copy of the first book is then stored on a storage portion of the electronic device.

### FIELD OF THE INVENTION

The instant invention relates generally to digital books or e-books, and more particularly to a method and system for distributing digital books.

### BACKGROUND OF THE INVENTION

A digital book, which is also known as an electronic book or an e-book, is the digital media equivalent of a conventional printed book. Typically, digital books are structured as virtual frames presented on a display device. During a reading session a user may turn or change from one virtual frame or “page” to another. Advantageously, the “pages” are not fixed permanently, and may be redefined or repaginated based on variances in display conditions, such as screen size, font type or size, margins, line spacing, resolution, etc.

Conveniently, digital books may be read on personal computers, personal digital assistants (PDAs), smart phones, etc., or on dedicated hardware devices known as e-book readers or e-book devices. Another convenience that is associated with digital books is the ability to purchase and download, or download and store, a reading selection directly from a digital library or commercial site. Some e-book readers, such as for instance Amazon's Kindle 2, use a 3G wireless network to allow the user to download digital books directly to the device, even if a Wi-Fi hotspot is not available. Other devices that can be “repurposed” for reading digital books, such as for instance Apple's IPod Touch, achieve similar functionality using a local wireless network connection.

Digital books currently offer several conveniences compared to conventional printed books. For instance: text can be searched automatically and cross-referenced using hyperlinks; font size and font type can be customized; non-permanent highlighting and annotation is supported; animated images or multimedia clips are supported; reading can resume automatically at the last read page, etc. In addition, a single e-book reader containing the text of several digital books is easier to carry around than the same books in printed form. Furthermore, the backlit display of an e-book reader allows for reading in low light, or even in total darkness.

Despite the advantages that are associated with digital books, many individuals still prefer to purchase a physical copy of a book rather than the corresponding digital version. For instance, many individuals enjoy the familiar experience that is associated with reading a physical copy of a book. On the other hand, some individuals do not require, or even desire, the portability and convenience that is associated with digital books. In addition, some individuals may fear the risk of losing data during prolonged storage of digital books. The end result is that a significant portion of book sales currently comprises the sale of physical books.

It would be advantageous to provide a method and system that overcomes at least some of the above-mentioned limitations of the prior art.

### SUMMARY OF EMBODIMENTS OF THE INVENTION

In accordance with an aspect of the invention there is provided a method comprising: in dependence upon purchasing a physical copy of a first book, receiving a code comprising an identifier of the first book; providing the code to an electronic device via an input portion thereof; establishing a communication session between the electronic device and a digital bookstore via a communication network; transmitting the code from the electronic device to the digital bookstore via the communication network during the communication session; in response to providing the code, receiving from the digital bookstore via the communication network a digital book copy of the first book; and, storing the digital book copy of the first book on a storage portion of the electronic device.

In accordance with an embodiment of the invention there is provided a method comprising: providing to a user, in dependence upon the user purchasing a physical copy of a first book, a code comprising an identifier of the first book; receiving at a digital bookstore a request signal that is transmitted via a communication network from an electronic device associated with the user, the request signal comprising the code;

Doc. No. 417-04 US processing the request signal to verify the code; in dependence upon verifying the code, retrieving data from a data storage portion of the digital bookstore, the retrieved data comprising a digital book version of the first book; and, transmitting the retrieved data from the digital bookstore to the electronic device via the communication network.

In accordance with an embodiment of the invention there is provided a method comprising: selling to a user a physical copy of a first book; providing to the user a code comprising an identifier of the first book; providing a digital bookstore comprising a data storage portion for storing data relating to a digital book copy of the first book; receiving at the digital bookstore a request signal comprising the code, the request signal transmitted from an electronic device associated with the user to the digital bookstore via a communication network; based on the code, retrieving the data relating to the digital book copy of the first book from the data storage portion; and, transmitting the retrieved data to the electronic device via the communication network.

### BRIEF DESCRIPTION OF THE DRAWINGS

Exemplary embodiments of the invention will now be described in conjunction with the following drawings, in which:

FIG. 1 is a simplified block diagram showing a system according to an embodiment of the instant invention;

FIG. 2 is a simplified flow diagram showing a method according to an embodiment of the instant invention;

FIG. 3 is a simplified flow diagram showing a method according to an embodiment of the instant invention; and,

FIG. 4 is a simplified flow diagram showing a method according to an embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

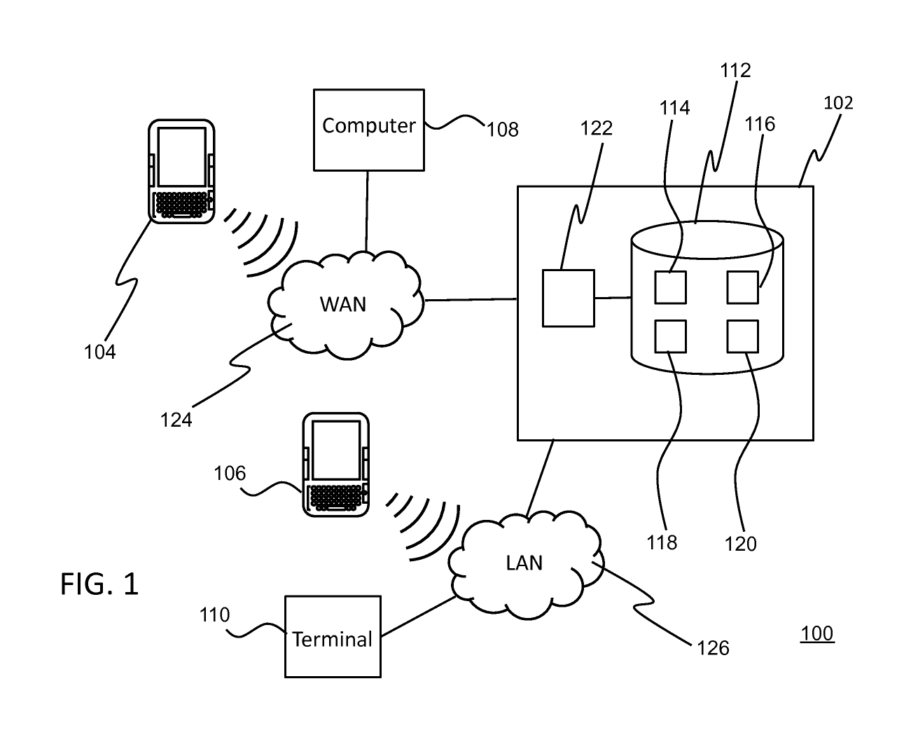

Referring to FIG. 1, shown is a simplified block diagram of a system 100 according to an embodiment of the instant invention. System 100 includes a digital bookstore 102 and a plurality of user devices, including portable electronic devices 104 and 106, and personal computer 108. The digital bookstore 102 includes a data storage system 112 for storing digital book content, including a first digital book 114, a second digital book 116, a third digital book 118, and a fourth digital book 120, etc. Additionally, the digital bookstore 102 includes a processor 122 having in execution thereon at least a process for controlling functions of the digital bookstore 102.

During use, a user purchases a physical copy of a book, either via an online bookstore or at a traditional bricks-and-mortar bookstore. Upon paying for the physical copy of the book, the user receives a code for downloading a digital book corresponding to the physical copy of the book. For instance, the code is printed on a cash register receipt that is issued to the user upon completing the purchase of the physical copy of the book at the traditional bricks-and-mortar bookstore, or the code is provided in a confirmation e-mail that is sent to the user upon completing the purchase of the book via the online bookstore. The user subsequently provides the code to the digital bookstore 102 in order to obtain the corresponding digital book. For instance, the user uses portable electronic device 104 or computer 108 to provide the code to the digital bookstore 102 via a wide area network (WAN) 124, such as for instance the Internet. The user may access the digital bookstore 102 via WAN 124 using the portable electronic device 104 or the computer 108 from virtually anywhere that an Internet connection is available. When the process in execution on the processor 122 verifies the code, then the digital book corresponding to the purchased physical copy of the book is provided to the portable electronic device 104 or computer 108 via WAN 124. Optionally, portable electronic device 104 connects to WAN 124 via a WI-FI network, via Bluetooth, or via a cellular network.

Alternatively, the user uses portable electronic device 106 to provide the code to the digital bookstore 102 via a local area network 126. For instance, when the user purchases the physical copy of the book at a traditional bricks-and-mortar bookstore, the user may immediately use the code to download the corresponding digital book to portable electronic device 106 via a local area network of the bookstore. In particular, the traditional bricks-and-mortar bookstore is a WI-FI hot spot and the digital book is downloaded to the portable electronic device 106 wirelessly.

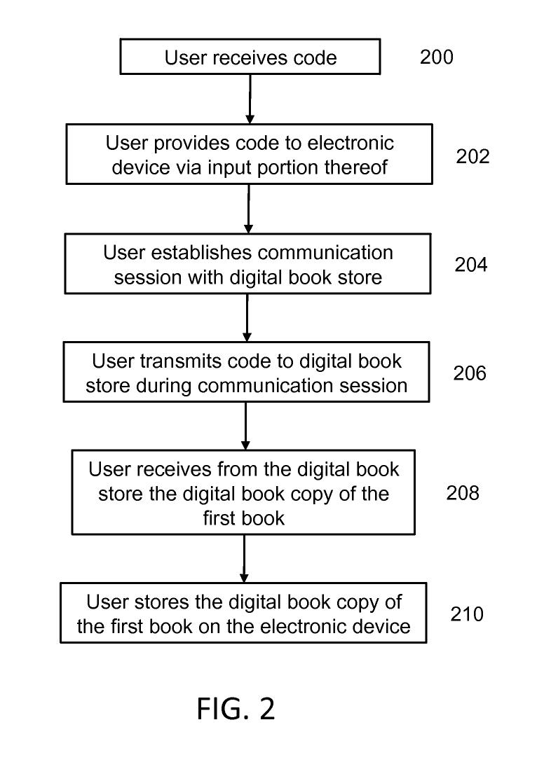

Referring now to FIG. 2, shown is a simplified flow diagram of a method according to an embodiment of the instant invention. At 200, in dependence upon a user purchasing a physical copy of a first book, the user receives a code comprising an identifier of the first book. For instance, if the user purchases the first book via a bricks-and-mortar bookstore then the code is either imprinted on a sales receipt for the first book, or the code is printed on a separate slip. Alternatively, if the user purchases the first book via an online bookstore, then the code is received as part of an e-mail confirmation that is sent to the user. At 202 the user provides the code to an electronic device via an input portion thereof. For instance, the user enters a string of alphanumeric characters via a keyboard of the electronic device, or the user scans the code that is imprinted on the sales receipt or other slip. At 204 a communication session is established between the electronic device and a digital bookstore via a communication network. For instance, the electronic device communicates with the digital bookstore via a wide area network such as the Internet, or via a local area network within a bricks-and-mortar bookstore, etc. At 206 the user transmits the code from the electronic device to the digital bookstore via the communication network during the communication session. In response to providing the code, at 208 the user receives from the digital bookstore via the communication network a digital book copy of the first book. At 210 the user stores the digital book copy of the first book on a storage portion of the electronic device.

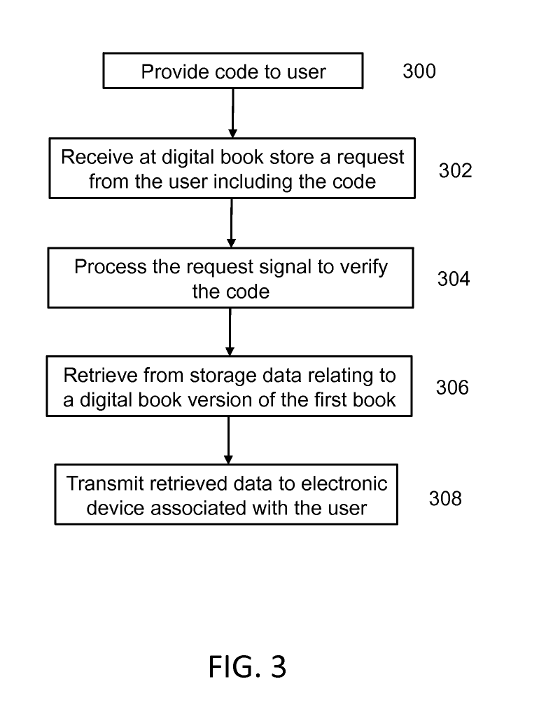

Referring now to FIG. 3, shown is a simplified flow diagram of a method according to an embodiment of the instant invention. At 300, in dependence upon a user purchasing a physical copy of a first book, a code comprising an identifier of the first book is provided to the user. At 302 request signal that is transmitted via a communication network from an electronic device associated with the user is received at a digital bookstore, the request signal comprising the code. At 304 the request signal is processed to verify the code. At 306, in dependence upon verifying the code, data is retrieved from a data storage portion of the digital bookstore, the retrieved data comprising a digital book version of the first book. At 308 the retrieved data is transmitted from the digital bookstore to the electronic device via the communication network.

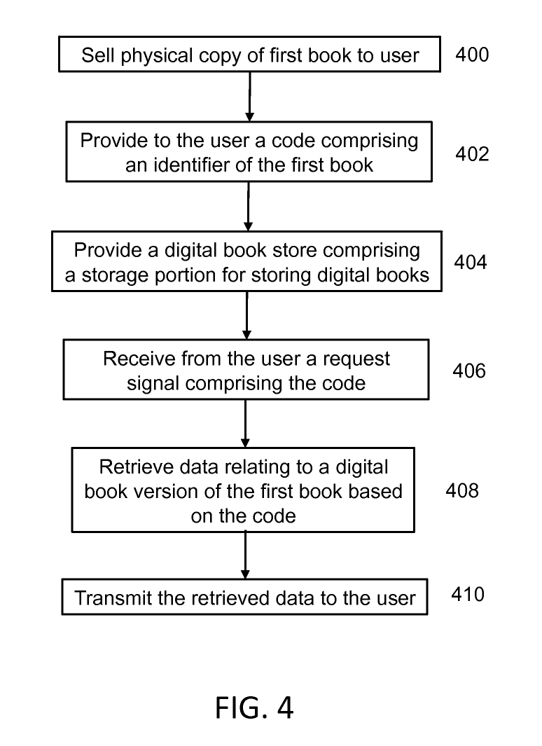

Referring now to FIG. 4, shown is a simplified flow diagram of a method according to an embodiment of the instant invention. At 400 a physical copy of a first book is sold to a user. At 402 a code comprising an identifier of the first book is provided to the user. At 404 a digital bookstore is provided, comprising a data storage portion for storing data relating to a digital book copy of the first book. At 406 a request signal is received at the digital bookstore, the request signal comprising the code, and the request signal transmitted from an electronic device associated with the user to the digital bookstore via a communication network. At 408, based on the code, the data relating to the digital book copy of the first book is retrieved from the data storage portion. At 410 the retrieved data is transmitted to the electronic device via the communication network.

Some non-limiting examples of portable electronic devices 104 and 106 include notebook computers, netbooks/subnotebooks, personal digital assistants (PDAs), smart phones such as for instance the Apple® iPhone®, Apple® iPad®, gaming devices such as for instance the Nintendo® DS, DS Lite or DSi, digital book readers such as for instance the Amazon Kindle 2, etc.

Numerous other embodiments may be envisaged without departing from the scope of the invention.

What is claimed is:

1. A method comprising:
in dependence upon purchasing a physical copy of a first book, receiving a code comprising an identifier of the first book;
providing the code to an electronic device via an input portion thereof;
establishing a communication session between the electronic device and a digital bookstore via a communication network;
transmitting the code from the electronic device to the digital bookstore via the communication network during the communication session;
in response to providing the code, receiving from the digital bookstore via the communication network a digital book copy of the first book; and,
storing the digital book copy of the first book on a storage portion of the electronic device.

2. A method according to claim 1, wherein the code is imprinted on a sales receipt for the physical copy of the first book.

3. A method according to claim 1, wherein the input portion of the electronic device comprises a keyboard, and wherein the code comprises a string of alphanumeric characters.

4. A method according to claim 1, wherein the input portion of the electronic device comprises a scanner, and wherein the code comprises a machine-readable symbol.

5. A method according to claim 1, wherein receiving the code comprises receiving an e-mail confirmation of the sale of the first book, the e-mail confirmation including the code.

6. A method according to claim 1, wherein the code is a single-use code.

7. A method comprising:
providing to a user, in dependence upon the user purchasing a physical copy of a first book, a code comprising an identifier of the first book;
receiving at a digital bookstore a request signal that is transmitted via a communication network from an electronic device associated with the user, the request signal comprising the code;
processing the request signal to verify the code;
in dependence upon verifying the code, retrieving data from a data storage portion of the digital bookstore, the retrieved data comprising a digital book version of the first book; and,
transmitting the retrieved data from the digital bookstore to the electronic device via the communication network.

8. A method according to claim 7, wherein providing the code comprises imprinting the code on a sales receipt for the physical copy of the first book.

9. A method according to claim 7, wherein providing the code comprises transmitting to the user an e-mail confirmation of the sale of the physical copy of the first book, the e-mail confirmation including the code.

10. A method according to claim 7, wherein verifying the code comprises verifying a first use of the code.

11. A method according to claim 7, wherein verifying the code comprises verifying that the electronic device is associated with the same user that purchased the physical copy of the first book.

12. A method comprising:
selling to a user a physical copy of a first book;
providing to the user a code comprising an identifier of the first book;
providing a digital bookstore comprising a data storage portion for storing data relating to a digital book copy of the first book;
receiving at the digital bookstore a request signal comprising the code, the request signal transmitted from an electronic device associated with the user to the digital bookstore via a communication network;
based on the code, retrieving the data relating to the digital book copy of the first book from the data storage portion; and,
transmitting the retrieved data to the electronic device via the communication network.

13. A method according to claim 12, wherein selling to the user the physical copy of the first book is performed via an on-line bookstore.

14. A method according to claim 12, wherein providing the code comprises transmitting to the user an e-mail confirmation of the sale of the physical copy of the first book, the e-mail confirmation including the code.

15. A method according to claim 12, wherein selling to the user the physical copy of the first book is performed via a bricks-and-mortar bookstore.

16. A method according to claim 12, wherein providing the code comprises imprinting the code on a sales receipt for the physical copy of the first book.
